(19) United States
(12) Patent Application Publication
(10) Pub. No.: US 2003/0061092 A1
(43) Pub. Date: Mar. 27, 2003

(54) Apparatus and method for providing collaborative voting while maintaining anonymity of individual voters

(75) Inventors: Rabindranath Dutta, Austin, TX (US); Krishna Kishore Yellepeddy, Austin, TX (US)

Correspondence Address: Duke W. Yee, Carstens, Yee & Cahoon, LLP, P.O. Box 802334, Dallas, TX, 75380, US

(73) Assignee: International Business Machines Corporation, Armonk, NY

(21) Appl. No.: 09/963,718

(22) Filed: Sep. 26, 2001

(51) Int. Cl. G06F 17/60

(52) U.S. Cl. 705/12

(57) ABSTRACT

An apparatus and a method for collaborative voting that maintains anonymity of the voters are provided. With the apparatus and method, information regarding voters is compiled into a database and used to generate one or more interfaces through which another voter or potential voter may be informed of the voting patterns of other voters. Through the apparatus and method, the voter or potential voter may select a subject, an individual voter, one or more groups of voters, a geographical voter area, voting information for various times, and the like. In response to such a selection, voting information for the corresponding selection is provided to the voter. In addition, the apparatus and method may provide an interface through which a voter may enter a comment or the like. The entered comments may then be viewed by other voters or potential voters when the submitter of the comment is selected or is part of a group of voters falling within a category selected by a voter or potential voter. As a further feature of the present invention, the voter's vote may be held in a non-final state during a predetermined period. During this predetermined period, the voter may view the voting information described above and either decide to change his/her vote or leave his/her vote as it was entered.

### BACKGROUND OF THE INVENTION

1. Technical Field

The present invention is directed to an apparatus and method for providing collaborative voting while maintaining anonymity of individual voters.

2. Description of Related Art

The Internet is becoming a principle fixture in modern culture for interacting with people in remote locations, conducting business, and obtaining information. With the increased importance of the Internet in today's society, Internet based voting has become more popular.

For example, some jurisdictions and corporations already have systems in place that allow voting on-line via the Internet. These systems, however, are very limited to providing users with the ability to cast their own vote without any ability to consult others before voting or obtaining information about persons or issues being voted on.

Often people like to consult other persons before voting. This is often true in the case of city-council, school board, etc., elections because candidates are not known very well to the people who must vote. Often family members, union members, or a group of friends geographically dispersed wish to decide, as a group, their voting choices and perform block voting such that all members of the group vote for the same candidate or the same way on an issue. However, in some instances, it may be desirable for the voter to maintain anonymity while determining how others have or are going to vote. The known systems do not provides such an ability.

### SUMMARY OF THE INVENTION

The present invention provides an apparatus and a method for collaborative voting that maintains anonymity of the voters. With the apparatus and method of the present invention, information regarding voters is compiled into a database and used to generate one or more interfaces through which another voter or potential voter may be informed of the voting patterns of other voters. Through the present invention, the voter or potential voter may select a subject, an individual voter, one or more groups of voters, a geographical voter area, voting information for various times, and the like. In response to such a selection, voting information for the corresponding selection is provided to the voter.

In addition, the present invention may provide an interface through which a voter may enter a comment or the like. The entered comments may then be viewed by other voters or potential voters when the submitter of the comment is selected or is part of a group of voters falling within a category selected by a voter or potential voter.

As a further feature of the present invention, the voter's vote may be held in a non-final state during a predetermined period. During this predetermined period, the voter may view the voting information described above and either decide to change his/her vote or leave his/her vote as it was entered. The predetermined period may be a predetermined time interval, such as from 9 a.m. To 7 p.m. On Nov. 11, 2001, a predetermined time interval from the time when the voter's vote was originally submitted, such as 3 hours from the time the vote was submitted, and the like. Other features and advantages of the present invention will be described in, or will become apparent to those of ordinary skill in the art in view of, the following detailed description of the preferred embodiments.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is an exemplary block diagram of a distributed data processing system in accordance with the present invention;

FIG. 2 is an exemplary block diagram of a server apparatus according to the present invention;

FIG. 3 is an exemplary block diagram of a client apparatus according to the present invention;

FIG. 4 is an exemplary block diagram of a voting coordination device according to the present invention;

FIG. 5 is an exemplary block diagram of a voter database entry according to the present invention;

FIG. 6A is an exemplary diagram of a voter interface for casting a vote according to the present invention;

FIG. 6B is an exemplary diagram of a voter interface for obtaining voter information based on one or more selected voter categories;

FIG. 6C is an exemplary diagram of a voter interface for displaying voter information according to the selected one or more voter categories;

FIG. 7 is a flowchart outlining an exemplary operation of the present invention when obtaining a vote from a voter; and

FIG. 8 is a flowchart outlining an exemplary operation of the present invention when providing voter information to another voter or potential voter.

### DETAILED DESCRIPTION OF THE PREFERRED EMBODIMENT

The present invention is directed to an apparatus and method for providing collaborative voting while maintaining anonymity of individual voting preferences. The present invention may be implemented as a service that is provided either completely or partially using a distributed computing system. As such, a brief explanation of a distributed data processing system in which the present invention may be implemented will be provided.

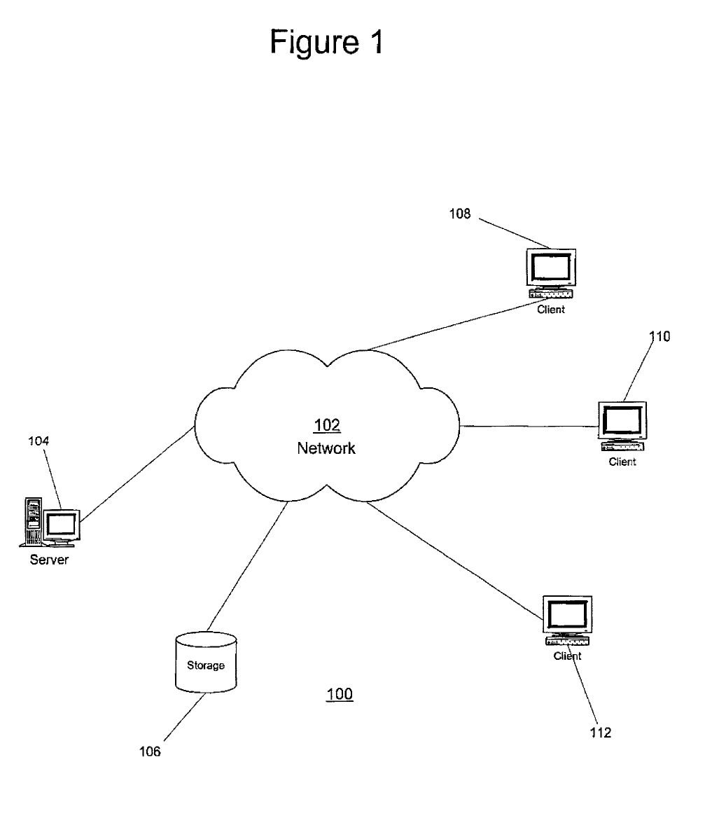

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, personal computers or network computers. In the depicted example, server 104 provides data, such as boot files, operating system images, and applications to clients 108-112. Clients 108, 110, and 112 are clients to server 104. Network data processing system 100 may include additional servers, clients, and other devices not shown. In the depicted example, network data processing system 100 is the Internet with network 102 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

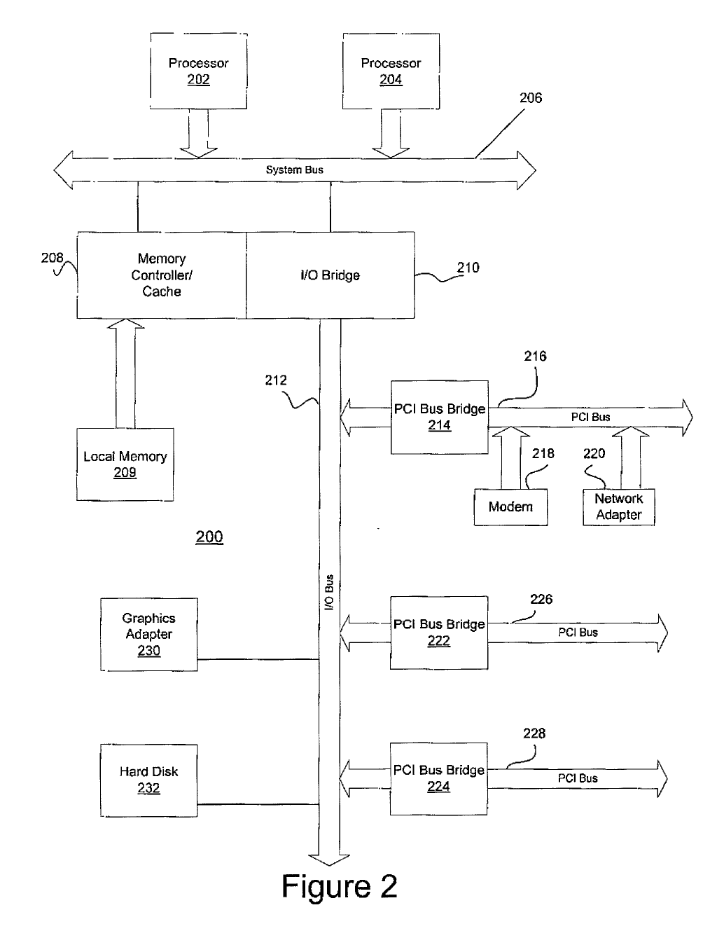

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to network computers 108-112 in FIG. 1 may be provided through modem 218 and network adapter 220 connected to PCI local bus 216 through add-in boards.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM e-Server pSeries system, a product of International Business Machines Corporation in Armonk, N.Y., running the Advanced Interactive Executive (AIX) operating system or LINUX operating system.

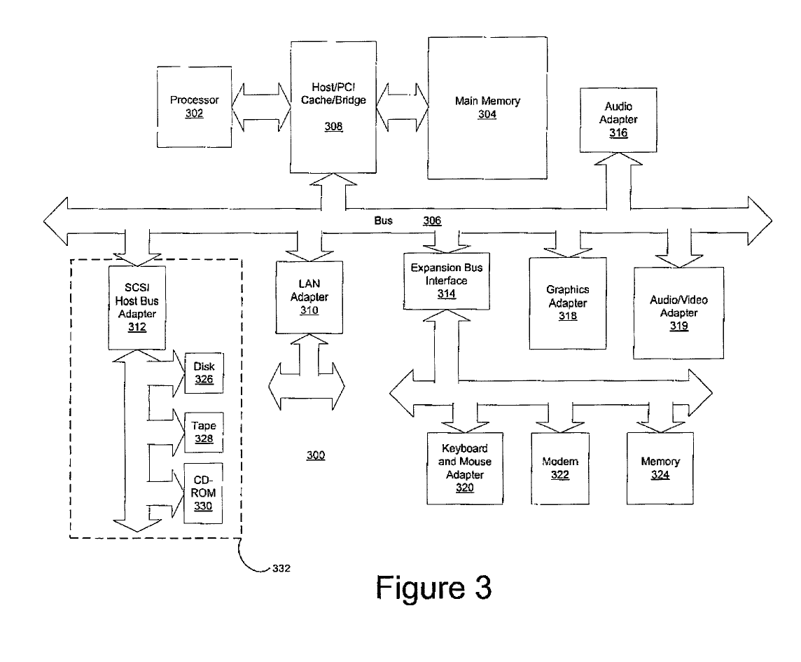

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows 2000, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash ROM (or equivalent nonvolatile memory) or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interface, whether or not data processing system 300 comprises some type of network communication interface. As a further example, data processing system 300 may be a Personal Digital Assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

Returning to FIG. 1, the present invention provides an apparatus and method for providing collaborative voting. With the present invention, a voting coordinator device is provided for coordinating the identification of voters, the control of voting, and the collection of votes and of voter data, and the providing of voter information to users in response to a user selection of a voter category. The voting coordinator device may be provided as a stand-alone dedicated machine or as part of a distributed data processing system.

In a preferred embodiment, the voting coordinator device is provided in a server apparatus, such as server 104 in FIG. 1. In such a distributed data processing system as that shown in FIG. 1, the server 104 may provide the voting coordinator device of the present invention, and clients 108-112 may be either personal computing devices, such as a users home personal computers, or dedicated voting machines, such as that described in U.S. Pat. No. 5,878,399, entitled “Computerized Voting System,” which is hereby incorporated by reference.

With the present invention, a user of a client device, such as client device 108, accesses the voting coordinator device resident on the server 104. The voting coordinator device stores information regarding votes and voters in a database, such as storage unit 106 a plurality of remotely located storage devices, or one or more local storage devices. The database preferably includes a listing of registered voters and their personal information, such as their address, telephone number, age, race, gender, and other demographic or voter information. In addition, the database may, after the voter has voted, maintain a record of the vote cast by the voter, whether the vote has been made permanent, and any comments that the voter may have made regarding the vote. This database information is used by the voting coordinator device to provide interfaces to other voters or potential voters when a voter category is selected.

The database information is preferably obtained at a time that the user registers as a voter. This information may also be gathered from company records, district records, and the like. At registration time, the user may be presented with a plurality of questions that the user may answer. Each question may be used to identify the user as part of a group of voters having a same characteristic, such as age range, race, gender, income level, job type, political party, and other demographic information. This information is then retained as an entry in the database along with an assigned voter identification.

In addition to storing information for individual voters, the database may maintain records of votes and comments by voters for various groups of voters. For example, separate tallies of votes for voters that are aged 25-30, 31-40, and the like. Similarly, separate tallies may be maintained for voters that live in particular geographical locations, such as voting districts, voters of particular races or gender, voters of particular income levels, and other demographic categories.

In addition, certain registered voters may be grouped together based on affiliations of the voters with one another. For example, if a voter indicates that he/she is a member of the National Rifle Association (NRA), this designation may be used to group the voter with other voters that are members of the NRA. Similarly, a user may enter a particular group identifier and be grouped with other voters having the same group identifier. In this way, for example, even members of families may be identified and grouped with one another. Thus, for example, if a voter enters a group identifier of “smithfamily” and another voter, such as a brother or sister, enters the same group identifier, these siblings will be grouped with one another.

The present invention provides a mechanism through which these various demographic categories and groupings may be selected by a user to thereby obtain information about the voting patterns of members of the category or grouping. This information may then be used by the user to help in determining how to vote or whether to change the user's vote in order to provide collaborative voting to remotely located voters.

When a user first accesses the voting coordinator device via the user's client device, the user may be presented with an interface through which the user may select a particular election, shareholders meeting, or initiative in which to vote. The user may select a particular election, shareholders meeting, or the like, at which time the voting coordinator device may request that the user enter a voter identification, such as a voter identification number, name, password, and the like.

The voting coordinator device verifies that the user is an eligible voter for the selected election, shareholder meeting, or the like, and then presents a voter interface through which the user may cast votes and/or obtain information regarding the voting patterns of other voters.

For example, the user may choose to view the number of votes cast for various candidates in an election from voters who are of African decent. Alternatively, the user may choose to have an aggregate number of votes cast by voters that are male and are between the ages of 20 and 25 be displayed. Any combination of voter categories may be combined to generate a display of the voting patterns of voters that fall into these categories.

The voting coordination device of the present invention retrieves information from the database based on the particular voter category or categories selected by the user and uses this information to generate a display of voting patterns for the selected categories. Such a display may include a display for each category chosen by the user as well as a display for a combination of the categories. That is, if a user selects to view votes cast by voters that are male and in the age range of 20-25, a window displaying the votes cast by voters that are male may be displayed, a window displaying the votes cast by voters that are 20-25 may be displayed, and a window displaying the votes cast by voters that are both male and 20-25 may alternatively, or in addition, be displayed.

The display of the voter patterns may be statically displayed or may be dynamically displayed. That is, the display may be updated as changes to the database information is made. Thus, for example, if a user chooses to view the votes cast by African American voters, the display may be provided to the user's client device in response to the request from the user. This display may be updated periodically such that changes to the database information are reflected in the display on the user's client device. In this way, the user is kept apprised of the current voter pattern for the selected voter category or categories.

While displaying the aggregate numbers of votes of the voters in the selected voter category or categories, an interface through which a user may view comments entered by the voters in the selected category or categories may be provided. In this way, the user may obtain information as to why the voter voted in the manner that they did. Such information may be helpful to the user when deciding how to cast his/her vote.

Sometimes voters wish to know how other voters having similar backgrounds as themselves vote on particular candidates or particular issues. The present invention provides a mechanism by which a voter may obtain information regarding the voting patterns of voters having similar backgrounds as themselves.

In a further embodiment of the present invention, the voter interface may further include an option to obtain voter pattern information for voters having similar voter profiles as the user. With such an option, a user's profile from the database is retrieved and other voter profiles in the database having voter characteristics similar to those set forth in the user's profile are obtained. The voter's votes may then be compiled into a display for the user. Such a display may include a ranking of the amount of similarity of the other voter to the current user, the voter's vote, and any comments entered by the voter. As with the aggregate displays above, the display according to this embodiment maintains the anonymity of the actual voters.

Once the user decides to cast a vote, the user may make use of the interface to enter the user's vote. The user's vote may be held in a non-final state until the expiration of a predetermined time period or until the user actively indicates that the vote is final and should be made permanent. The predetermined time period may be a time interval, a designated elapsed time from when the vote is initially cast, or the like. During this period, the vote may be changed by the user. However, after the elapse of the predetermined time period, or when the user indicates his/her vote to be final, the vote is made permanent and cannot be changed.

Since votes may be changeable during the predetermined time period, the displays of voter patterns may further include an indicator of how many votes are permanent and how many are non-final. Such an indicator may be an indication to a user as to the possible margin of error of the current state in relation to the possible final outcome of the voting as well as an indication of the conviction of the voters to a particular candidate or stance on an issue.

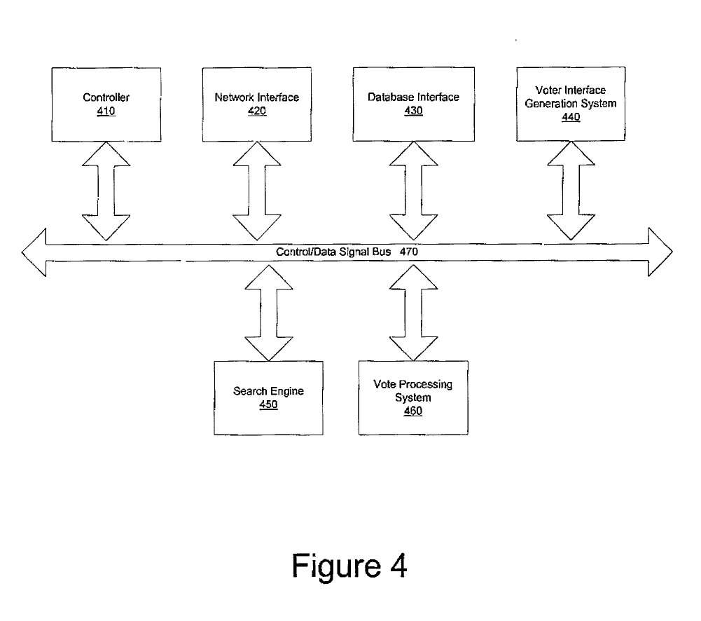

FIG. 4 is an exemplary block diagram illustrating a voting coordinator device according to the present invention. The elements shown in FIG. 4 may be implemented in hardware, software, or a combination of hardware and software. In a preferred embodiment, the elements in FIG. 4 are implemented as computer instructions executed by one or more processors.

As shown in FIG. 4, the voting coordinator device includes a controller 410, a network interface 420, a database interface 430, a voter interface generation system 440, a search engine 450, and a vote processing system 460. The elements 410-460 are coupled to one another via the control/data signal bus 470. Although a bus architecture is shown in FIG. 4, the present invention is not limited to such and any architecture facilitating the communication of control/data signals between the elements 410-460 may be used without departing from the spirit and scope of the present invention.

The controller 410 controls the overall operation of the voting coordinator device and orchestrates the operation of the other devices 420-460. In operation, the controller 410 receives a logon request from a client device via the network interface 420. In response, the controller 410 instructs the voter interface generation system 440 to provide a voter interface, i.e. a user interface, to the client device. The voter interface provides the user of the client device with a means by which the user may select an election, shareholder meeting, or the like, to participate in and also provide voter identification information.

The controller 410 then receives a selection of an election, shareholder meeting, or the like, from the user of the client device along with a voter identification of the user. The controller 410 instructs the search engine 450 to retrieve the voter profile for the entered voter identification from a voter database via the database interface 430. As previously mentioned, the voter database may be local or remote with respect to the voting coordinator device.

The controller 410 then validates the voter identification information provided by the user of the client device based on the voter profile retrieved, if any. Upon validation of the voter identification, the voter interface generation system 440 sends a voter interface to the client device through which the user may select to obtain voter information for various categories and/or groupings of voters. In addition, the voter may select to cast a vote.

If the user enters a selection to retrieve voter voting pattern information based on one or more voter categories or groupings, the selection is sent to the controller 410 which then instructs the search engine to retrieve voter voting pattern information from the voter database based on the selected voter categories or groupings. The results are returned to the controller 410 which then instructs the voter interface generation system 440 to generate one or more interfaces through which the results may be displayed.

If the user chooses to cast his/her vote, the choice to do so is provided to the controller 410 which then instructs the voter interface generation system 440 to provide an interface through which the user may enter his/her vote and any comments the user may have. Such an interface will be different depending on the particular election, shareholders meeting, or the like, in which the user is voting. The entries by the user into this interface may then be transmitted back to the controller 410 which instructs the vote processing system 460 to store the vote and any comments accordingly in the voter database.

The vote processing system 460 may further manage whether or not votes that have been cast are non-final or permanent. The vote processing system 460 may periodically or at the elapsing of a predetermined time period, check each entry in the voter database and update the status of the votes as to whether they are non-final or permanent. In addition, the vote processing system 460 may change the status of a vote from non-final to permanent at the explicit instruction to do so by the user via a voting interface.

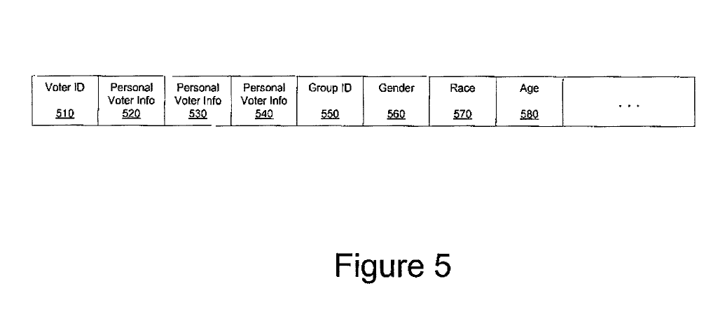

FIG. 5 is an exemplary diagram of a voter database entry according to the present invention. As shown in FIG. 5, the voter database entry includes a field 510 for a voter identification and fields 520-540 for personal voter information such as name, address, telephone number, and the like. The voter database entry further includes fields 550-590 for entry of voter category information, such as a group identifier (field 550), a gender (field 560), a race (field 570), an age range (field 580), and the like.

Searches on the fields may be performed by the voting coordinator device of the present invention for voter validation and voter voting pattern information retrieval. With voter validation, the information in fields 510-540 may be used to perform the validation. With voter voting pattern information retrieval, the information in fields 550-590 may be used to generate a display of voter voting patterns for use by another voter or potential voter.

With the present invention, the when a user requests voter voting pattern information, only the information in the voter category fields 550-590 may be displayed to the user. Thus, the voter's voter identification and personal information in fields 510-540, is never provided to other users. In this way, the anonymity of the voter is maintained while still providing the user with valuable information in aiding the user in casting his/her vote.

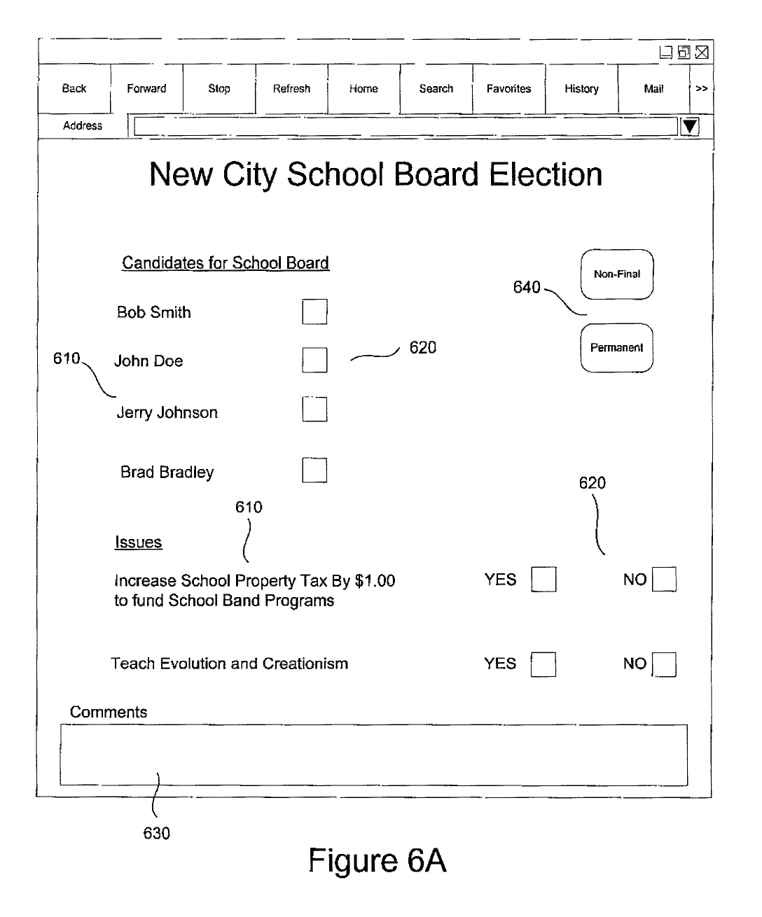

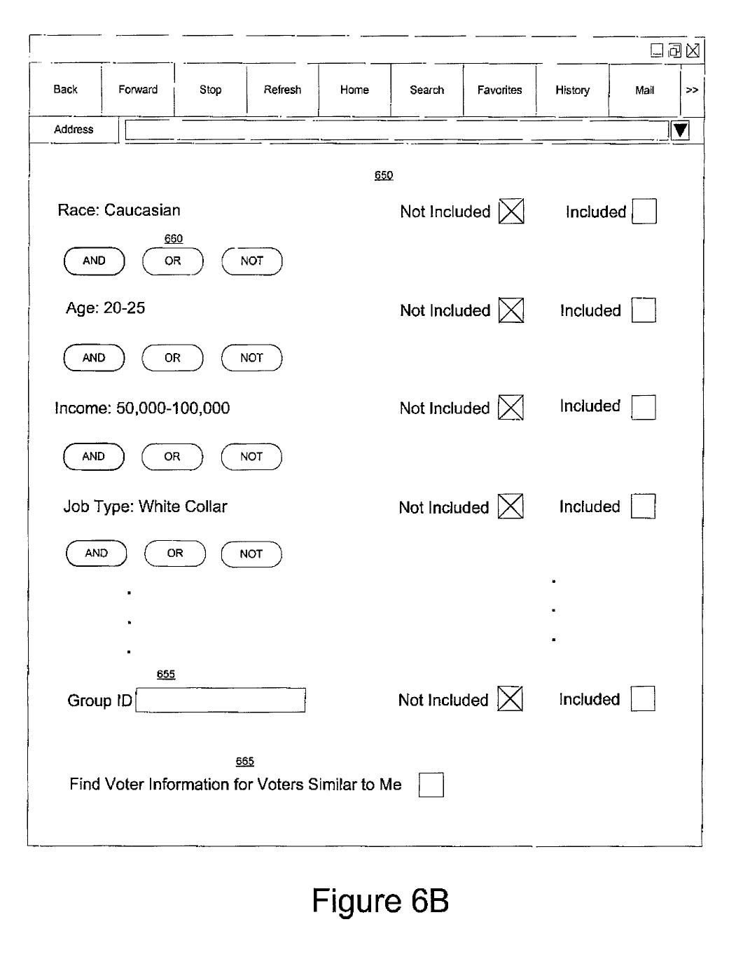

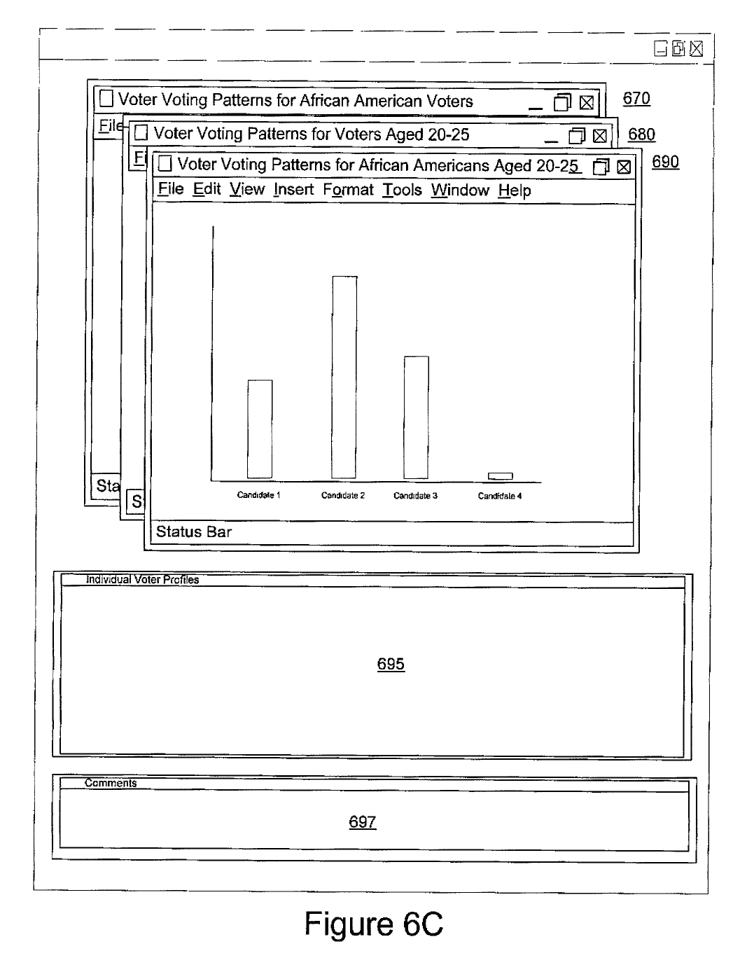

FIG. 6A is an exemplary diagram of a voter interface for casting a vote according to the present invention. As shown in FIG. 6A, the interface includes a listing of candidates or issues 610 and corresponding possible votes 620. The user may select one of the possible votes 620 for each issue and/or candidate. Of course there are limitations on the voting allowed by the voting coordinator device. For example, if there a number of candidates for a single position, only one of the candidates may be chosen. Similarly, a voter may not select both yes and no for an issue.

In addition, to the listings above, the interface provides a comment section 630 in which a user may enter a limited length comment for inclusion when the user's voting information is retrieved by a subsequent user. The comment may be a text comment of a predetermined length and is stored in association with the user's vote and other voter information in a voter profile entry in the voter database.

Also provided on the interface is an option to make the vote permanent or non-final 640. Based on the selection of either permanent or non-final, the vote processing system 560 flags the vote as either changeable or not changeable in the voter database. If the vote is changeable, within the predetermined time period the user may log onto the voting coordinator device again and change his/her vote using the voting interface of FIG. 6A.

FIG. 6B is an exemplary diagram of a voting interface for obtaining voter information based on one or more selected voter categories. As shown in FIG. 6B, the voting interface includes a listing 650 of possible voter categories that may be selected. The listing 650 of voter categories includes the option 655 to select a particular group identifier.

In addition, the listing includes operand selections 660 for selecting whether to perform an AND, OR, or NOT operation on the combination of voter categories. For example, a user may select to retrieve voter voting pattern information for voters that are age 20-25 AND African American. Alternatively, the user may select to retrieve voter voting pattern information for voters that are age 20-25 and NOT African American.

Moreover, the voting interface of FIG. 6B may include an option 665 to search for voter profiles that are similar to the present user's voter profile. By selecting this option 665, the voter database is searched for voters meeting a minimum requirement of similarity with the present user's voter profile and the results accumulated for display to the user.

The selection of voter categories and/or groups is used to create a search query that is used by the search engine 450 to search the voter database for corresponding entries. The results of the search are then provided in another voting interface used to display the results of the retrieval of voter voting patterns.

FIG. 6C is an exemplary diagram of a voting interface for displaying the results of a voter voting pattern search. As shown in FIG. 6C, the voting interface includes one or more windows in which results of the search are displayed. For example, as described above, there may be one or more windows 670-690 illustrating the voting patterns of voters meeting each of the voter categories selected by the user as well as a combination of the voter categories.

In addition, a window or field 695 may be provide in which a listing of voter database entry category information for each voter falling into the grouping of voters identified by the combination of voter categories in the search query. If the user selected the option 665 for identifying voter voting pattern information for voters having a similar voter profile, the window or field 695 may further include an indicator of the similarity of the voter profile with the user's voter profile.

From the list of voter database entry category information, a particular voter database entry may be selected from the listing and thereby, a corresponding comment entered by the voter may be displayed to the user via the comment window or field 697. At no time is the voter identifier or voter personal information for the voter provided to the user via the voting interface of FIG. 6C.

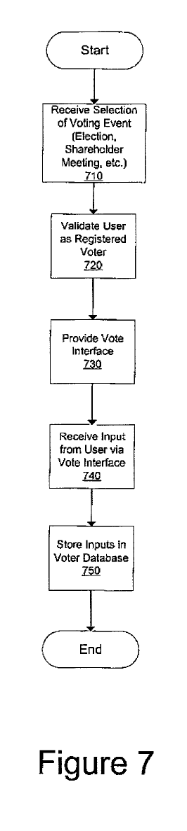

FIG. 7 is a high level flowchart outlining an exemplary operation of the present invention when obtaining a vote from a voter. As shown in FIG. 7, the operation starts with receiving a selection of a voting event, such as a particular election, shareholder meeting, and the like, from a user (step 710). The user is then validated as a registered voter for the selected voting event (step 720). This may also include verifying that the user has not previously submitted a permanent vote through a voter database lookup.

Once the user is validated, the user is provided with a voting interface (step 730). The user's input to the voting interface is received (step 740). This input may include the user's votes as well as any comments the user may have entered. The user's input is then stored as part of a voter database entry for later use in providing voter voting pattern information to subsequent voters (step 750).

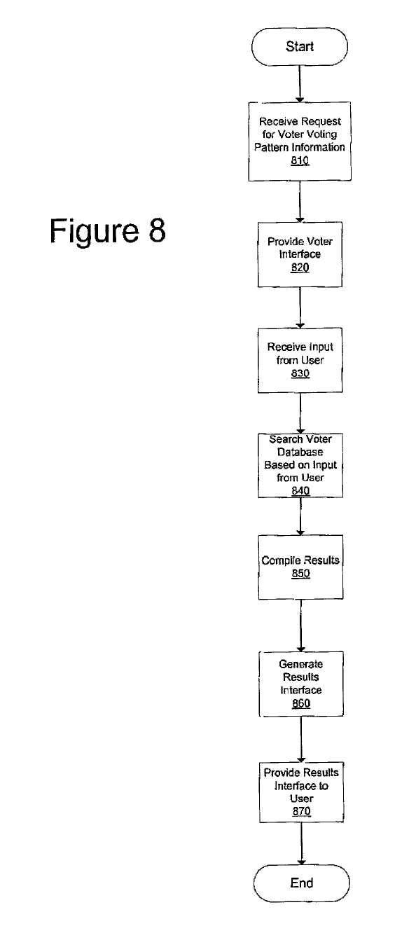

FIG. 8 is a high level flowchart outlining an exemplary operation of the present invention when providing voter information to another voter or potential voter. As shown in FIG. 8, the operation starts with receiving a request for voter voting pattern information (step 810). A voter voting pattern interface is then provided (step 820) and a user's input into the interface is received (step 830). This input may include selections of voter categories and operands to thereby generate a search query. Alternatively, the input may be a selection of an option to search for voters similar to the user.

In either case, the voter database is searched for voters matching the designated voter categories according to the grouping defined by the operands, or alternatively for voters matching a voter profile of the user (step 840). The results of the search are compiled (step 850) and a results interface is generated (step 860). The results interface may include several windows for displaying different portions of the search results. The results interface is then provided to the user (step 870).

Thus, the present invention provides an apparatus and method for providing collaborative voting while maintaining the anonymity of voters. The present invention allows a voter to obtain current information about the voting patterns of other voters so that this information may aid the voter in casting his/her vote. In this way, voters may collaborate in their voting by viewing the voting patterns of others. However, the individual identities of the voters are never revealed.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method of collaborative voting, comprising:
receiving a request for voter voting information;
providing the requested voter voting information in an anonymous manner such that the identities of individual voters are not disclosed; and
receiving a vote based on the voter voting information.

2. The method of claim 1, wherein receiving a request for voter voting information includes receiving a selection of one or more voter categories for which voter voting information is to be provided.

3. The method of claim 2, wherein the one or more voter categories are based on one or more of age, race, gender, income level, occupation, and political party affiliation.

4. The method of claim 2, wherein the one or more voter categories are based on demographic information.

5. The method of claim 2, wherein the one or more voter categories are based on voter affiliations with other voters.

6. The method of claim 5, wherein the voter affiliations with other voters are identified by a group identifier.

7. The method of claim 1, wherein providing the requested voter voting information includes outputting the voter voting information in a graphical form on a display device.

8. The method of claim 2, wherein providing the requested voter voting information includes providing voter voting information for each of the one or more voter categories selected.

9. The method of claim 2, wherein providing the requested voter voting information includes providing voter voting information for a combination of the one or more voter categories selected.

10. The method of claim 8, wherein providing the requested voter voting information further includes providing voter voting information for a combination of the one or more voter categories selected.

11. The method of claim 1, wherein providing the requested voter voting information includes providing a dynamically updated display of the requested voter voting information.

12. The method of claim 1, wherein providing the requested voter voting information includes providing voter comments entered by voters included in the voter voting information.

13. The method of claim 1, wherein the request for voter voting information includes a request for voter voting information for voters having similar characteristics as a user that submitted the request.

14. The method of claim 13, wherein providing the requested voter voting information includes:
retrieving characteristics for the user; and
searching a voter database for voter entries corresponding to one or more of the characteristics for the user.

15. The method of claim 13, wherein providing the requested voter voting information includes providing a ranking of an amount of similarity between other voters' characteristics and the user's characteristics.

16. The method of claim 1, wherein receiving a vote based on the voter voting information includes receiving an indication of whether the vote is permanent or non-final.

17. The method of claim 16, wherein if the vote is non-final, the vote may be changed within a predetermined period of time from when the vote was received.

18. The method of claim 1, wherein the voter voting information includes information regarding non-final votes and permanent votes cast by voters, and wherein providing the voter voting information includes providing non-final votes in a format different from permanent votes.

19. The method of claim 1, further comprising:
storing an indication of the vote in association with voter characteristic information of the voter that submitted the vote.

20. The method of claim 19, wherein storing an indication of the vote further includes storing an indication of the status of the vote as being either non-final or permanent.

21. A computer program product in a computer readable medium for providing collaborative voting, comprising:
first instructions for receiving a request for voter voting information;
second instructions for providing the requested voter voting information in an anonymous manner such that the identities of individual voters are not disclosed; and
third instructions for receiving a vote based on the voter voting information.

22. The computer program product of claim 21, wherein the first instructions for receiving a request for voter voting information include instructions for receiving a selection of one or more voter categories for which voter voting information is to be provided.

23. The computer program product of claim 22, wherein the one or more voter categories are based on one or more of age, race, gender, income level, occupation, and political party affiliation.

24. The computer program product of claim 22, wherein the one or more voter categories are based on demographic information.

25. The computer program product of claim 22, wherein the one or more voter categories are based on voter affiliations with other voters.

26. The computer program product of claim 25, wherein the voter affiliations with other voters are identified by a group identifier.

27. The computer program product of claim 21, wherein the second instructions for providing the requested voter voting information include instructions for outputting the voter voting information in a graphical form on a display device.

28. The computer program product of claim 22, wherein the second instructions for providing the requested voter voting information include instructions for providing voter voting information for each of the one or more voter categories selected.

29. The computer program product of claim 22, wherein the second instructions for providing the requested voter voting information include instructions for providing voter voting information for a combination of the one or more voter categories selected.

30. The computer program product of claim 28, wherein the second instructions for providing the requested voter voting information further include instructions for providing voter voting information for a combination of the one or more voter categories selected.

31. The computer program product of claim 21, wherein the second instructions for providing the requested voter voting information include instructions for providing a dynamically updated display of the requested voter voting information.

32. The computer program product of claim 21, wherein the second instructions for providing the requested voter voting information include instructions for providing voter comments entered by voters included in the voter voting information.

33. The computer program product of claim 21, wherein the request for voter voting information includes a request for voter voting information for voters having similar characteristics as a user that submitted the request.

34. The computer program product of claim 33, wherein the second instructions for providing the requested voter voting information include:
instructions for retrieving characteristics for the user; and
instructions for searching a voter database for voter entries corresponding to one or more of the characteristics for the user.

35. The computer program product of claim 33, wherein the second instructions for providing the requested voter voting information include instructions for providing a ranking of an amount of similarity between other voters' characteristics and the user's characteristics.

36. The computer program product of claim 21, wherein the third instructions for receiving a vote based on the voter voting information include instructions for receiving an indication of whether the vote is permanent or non-final.

37. The computer program product of claim 36, wherein if the vote is non-final, the vote may be changed within a predetermined period of time from when the vote was received.

38. The computer program product of 21, wherein the voter voting information includes information regarding non-final votes and permanent votes cast by voters, and wherein the second instructions for providing the voter voting information include instructions for providing non-final votes in a format different from permanent votes.

39. The computer program product of claim 21, further comprising:
fourth instructions for storing an indication of the vote in association with voter characteristic information of the voter that submitted the vote.

40. The computer program product of claim 39, wherein the fourth instructions for storing an indication of the vote further include instructions for storing an indication of the status of the vote as being either non-final or permanent.

41. An apparatus for providing collaborative voting, comprising:
means for receiving a request for voter voting information;
means for providing the requested voter voting information in an anonymous manner such that the identities of individual voters are not disclosed; and
means for receiving a vote based on the voter voting information.

42. A method for providing collaborative voting, comprising:
a first interface through which a selection of one or more voter characteristics is received, wherein a search of voter voting information is performed based on the selection of one or more voter characteristics; and
a second interface through which results of the search of voter voting information are provided in an anonymous manner such that the identities of individual voters are not disclosed.

43. The method of claim 42, wherein the first interface includes a field for entering a group identifier as one of the one or more voter characteristics.

44. The method of claim 42, wherein the first interface includes a field for selecting an option to find voter voting information for voters have characteristics similar to a user of the first interface.

45. The method of claim 42, wherein the first interface includes a plurality of fields for selecting the one or more voter characteristics and a plurality of corresponding fields for selecting whether a voter having a corresponding one of the one or more voter characteristics is to be included in the search results or not included in the search results.

46. The method of claim 42, wherein the second interface includes a portion for outputting results of the search of voter voting information for each of the one or more selected voter characteristics.

47. The method of claim 46, wherein the second interface further includes a portion for outputting results of the search of voter voting information for a combination of the one or more selected voter characteristics.

48. The method of claim 42, wherein the second interface is dynamically updated.

49. The method of claim 42, wherein the second interface includes a field for outputting individual voter profiles of voters included in the results of the search of voter voting information.

50. The method of claim 42, wherein the second interface includes a field for outputting comments submitted by individual voters included in the results of the search of the voter voting information.

51. The method of claim 42, further comprising a third interface through which a user may submit a vote, wherein when the user submits the vote, the second interface is updated.
